(19) United States
(12) Patent Application Publication
(10) Pub. No.: US 2015/0351363 A1
(43) Pub. Date: Dec. 10, 2015

(54) CRATE COVER ASSEMBLY FOR A PET CRATE

(71) Applicant: Jonathan Nussbaum, Miami, FL (US)

(72) Inventor: Jonathan Nussbaum, Miami, FL (US)

(21) Appl. No.: 14/732,427

(22) Filed: Jun. 5, 2015

Related U.S. Application Data
(60) Provisional application No. 62/008,390, filed on Jun. 5, 2014.

(51) Int. Cl. A01K 1/035; E04H 15/02; A01K 1/03

(52) U.S. Cl. CPC A01K 1/035; A01K 1/034; E04H 15/02

(57) ABSTRACT

A crate cover assembly for covering a pet crate that includes a crate top having a crate top perimeter, a crate bottom perimeter, and at least one crate side wall, includes: a frame assembly positioned on the crate top, the frame assembly including (i) a frame base having a base perimeter that is sized and shaped to match the size and shape of the top perimeter of the pet crate, and (ii) a frame support structure that extends upward from the frame base; and a cover assembly that fits over and covers the frame assembly.

### RELATED APPLICATION

This application claims priority on U.S. Provisional Application Ser. No. 62/008,390, filed Jun. 5, 2014 and entitled “CRATE COVER ASSEMBLY FOR A PET CRATE”. As far as permitted, the contents of U.S. Provisional Application Ser. No. 62/008,390 are incorporated herein by reference.

### BACKGROUND

Pet crates are helpful for pets and owners. Unfortunately pet crates can be unsightly and difficult to customize to a specific decorating style.

### SUMMARY

The present invention is directed towards a crate cover assembly for covering a pet crate that includes a crate top having a crate top perimeter, a crate bottom perimeter, and at least one crate side wall. In one embodiment, the crate cover assembly includes: a frame assembly positioned on the crate top, the frame assembly including (i) a frame base having a base perimeter that is sized and shaped to match the size and shape of the top perimeter of the pet crate, and (ii) a frame support structure that extends upward from the frame base; and a cover assembly that fits over and covers the frame assembly.

In one embodiment, the frame base is generally rectangular shaped, the frame support structure is pyramidal shaped and includes a plurality of support rods extending away from the frame base, and the cover assembly includes a top cover that is pyramidal shaped. Additionally, the pet crate cover assembly can include at least one side curtain that selectively attaches to the frame support structure to cover at least a portion of the crate side wall.

In another embodiment, the present invention is directed to a combination that includes the pet crate cover assembly and a pet crate that is generally rectangular shaped with four crate side walls, a crate top perimeter and a crate bottom perimeter, and at least one pet door.

In one embodiment, the frame base includes a base perimeter, and the frame base is adjustable to change the size and shape of the base perimeter. For example, the frame base can include a plurality of adjustable joints.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a pet crate assembly including a pet crate and a crate cover assembly having features of the present invention;

FIG. 2 is a perspective view of a first embodiment of a frame assembly attached to a pet crate, the design of the pet crate in FIG. 2 is slightly different than the design of the pet crate in FIG. 1;

FIG. 3 is an alternate perspective view of FIG. 2 with side panel curtains extended to cover the side walls of the pet crate;

FIG. 4A is a perspective view of the first embodiment of the frame assembly in which a crate cover assembly is attached to and covers the frame assembly;

FIG. 4B is a perspective view of the first embodiment of the frame assembly in which the frame assembly is attached to a pet crate;

FIG. 4C is a perspective view of the first embodiment of the frame assembly in which the frame assembly is detached from a pet crate;

FIG. 4D is an alternate perspective view of FIG. 4C;

FIG. 4E is a perspective view of the frame assembly in which the frame support beams are connected to the top connector and the corner connectors using ball and socket joints; the front beam, rear beam, and side beams are connected to corner connectors through apertures in the corner connectors;

FIG. 4F is an exploded perspective view of the first embodiment of the frame assembly in which the front beam, rear beam, and side beams are detached from the apertures of the corner connectors;

FIG. 4G is an alternate perspective view of FIG. 4F;

FIG. 4H is a perspective view of the frame assembly in which a frame support beam is connected to a top connector joint and a corner connector joint and in which a side beam and a rear beam are detached from the apertures of the corner connector joint;

FIG. 4I is an alternate perspective view of FIG. 4H;

FIG. 4J is a perspective view in which a corner connector joint contains a socket which receives a ball to connect a frame support beam to the corner connector joint;

FIG. 4K is an alternate perspective view of FIG. 4J;

FIG. 4L is a perspective view of a top connector joint containing ball and socket joints to connect the frame support beams to the top connector joint;

FIG. 4M is an alternate perspective view of FIG. 4L;

FIG. 4N is a perspective view in which the front beam, rear beam, and side beams have been detached from the frame assembly and the frame assembly has been compressed from a generally pyramidal shaped to a generally lineal shape;

FIG. 4O is an alternate perspective view of FIG. 4N;

FIG. 4P is an alternate perspective view of FIG. 4O;

FIG. 5A is a perspective view of a second embodiment in which the crate cover assembly is attached to the frame base and frame support structure;

FIG. 5B is an alternate perspective view in which the crate cover assembly is detached from the frame base and frame support structure;

FIG. 5C is a perspective view of the frame base and frame support structure of the frame assembly;

FIG. 5D is an exploded perspective view of the frame base and frame support structure of the frame assembly;

FIG. 5E is an exploded perspective view of a portion of the frame assembly shown in FIG. 5D; and

FIG. 5F is an alternate exploded perspective view of a portion of the crate cover assembly shown in FIG. 5D.

### DESCRIPTION

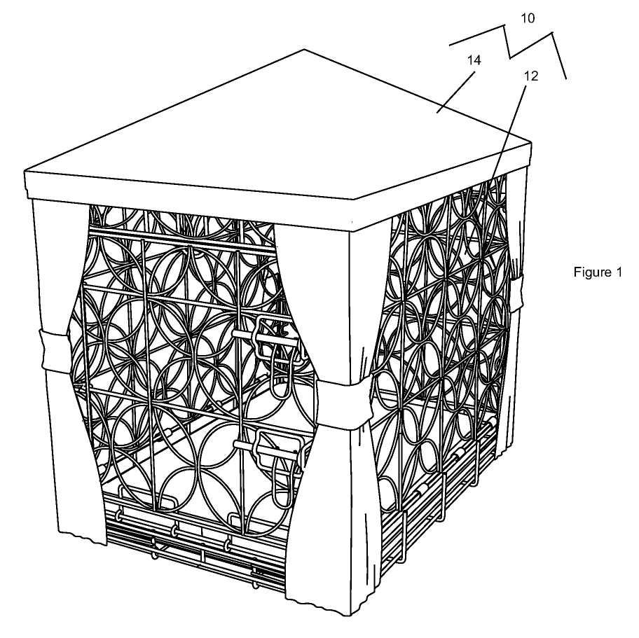

Referring to FIG. 1, the present invention is directed toward a pet crate assembly 10 that includes a pet crate 12, and a crate cover assembly 14. As provided herein, the crate cover assembly 14 is uniquely designed to be selectively attached to and detached from the pet crate 12 without damaging the pet crate 12 or the crate cover assembly 14. Moreover, the crate cover assembly 14 is designed such that multiple, alternative crate cover assemblies 14 can also be selectively attached to and detached from the pet crate 12 without damaging the pet crate 12 or the crate cover assemblies 14. With this design, the crate cover assembly 14 can be used to easily add design flair to an existing pet crate 12 or a new pet crate 12. As a result thereof, the pet crate assembly 10 can be positioned in a prominent location in a home or other location as a decorative piece, instead of something that is hidden in the garage or spare bedroom.

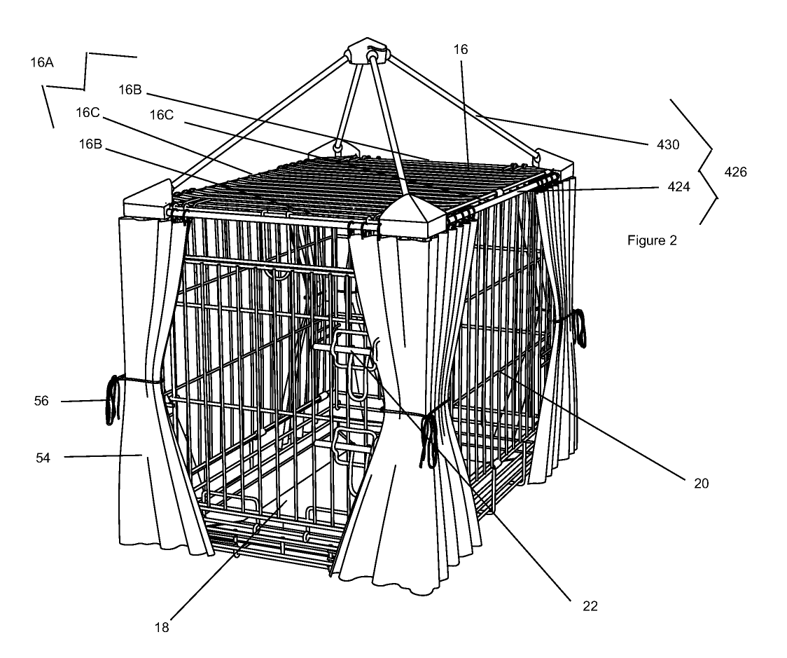

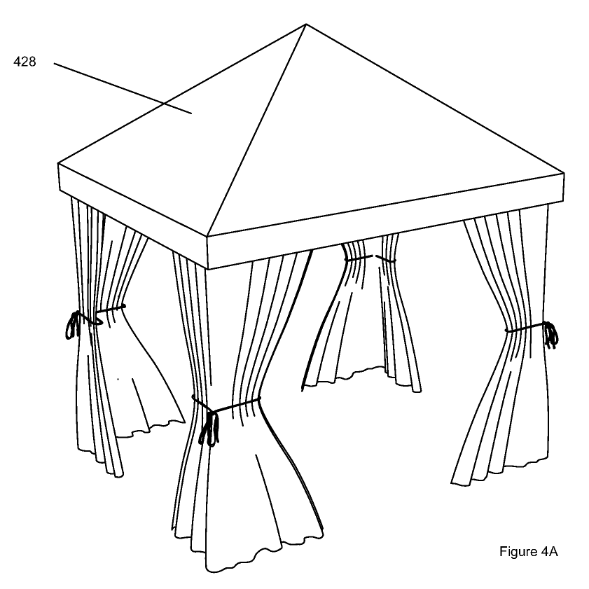

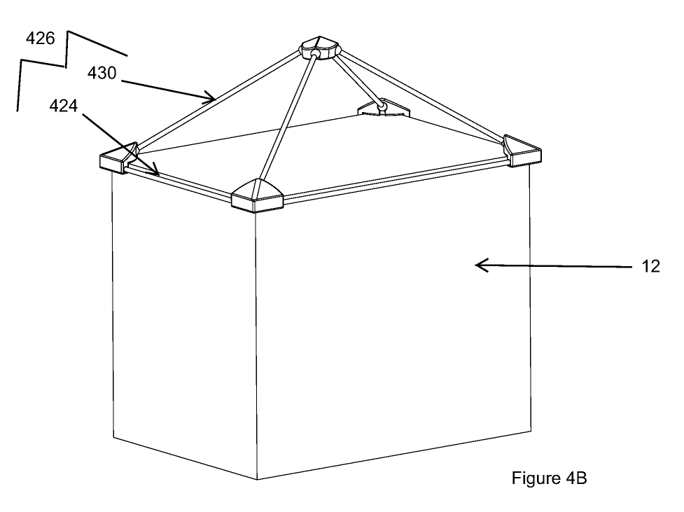

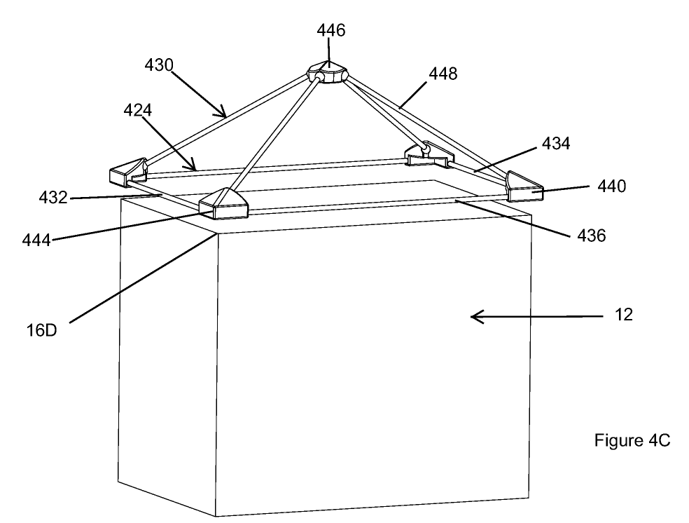

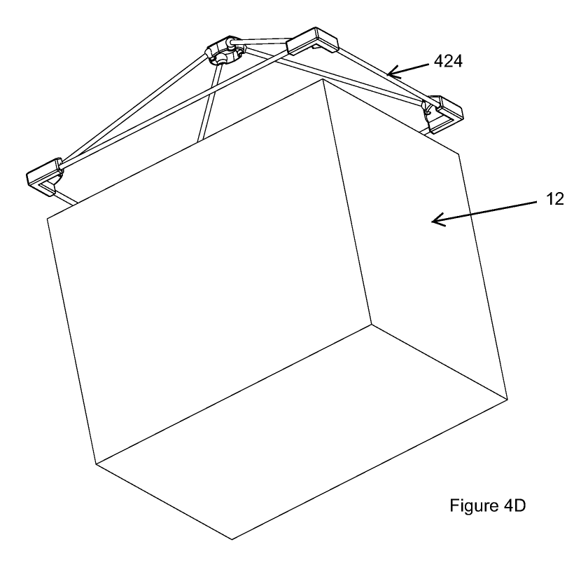

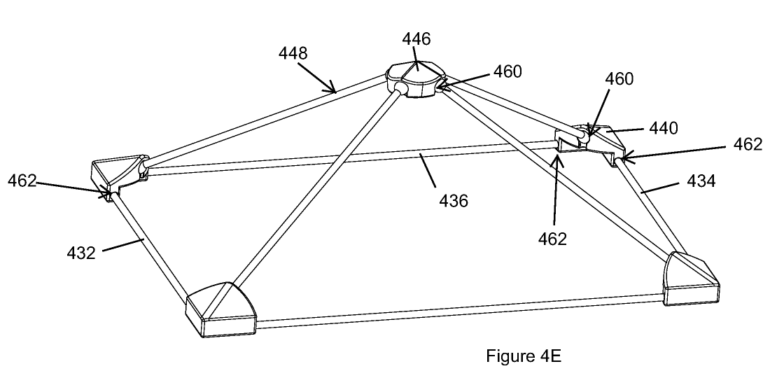

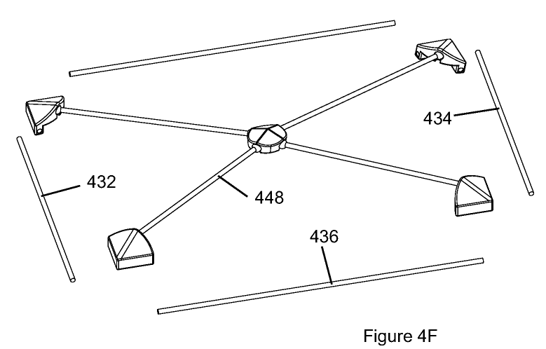

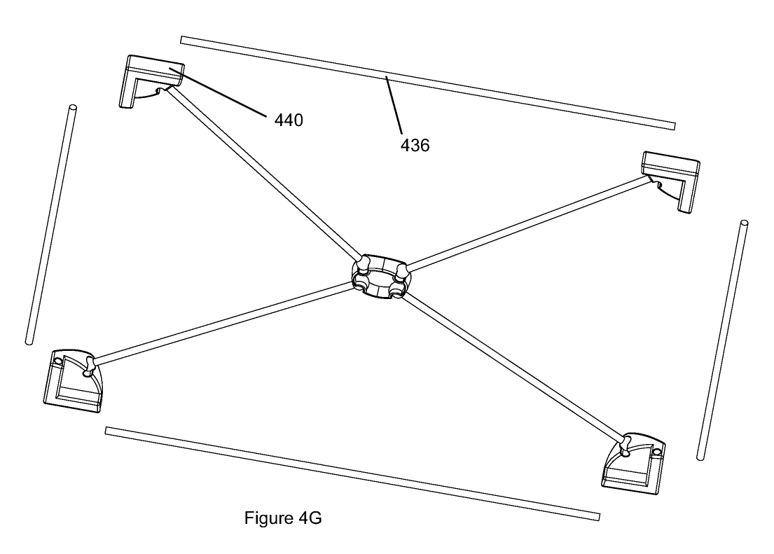

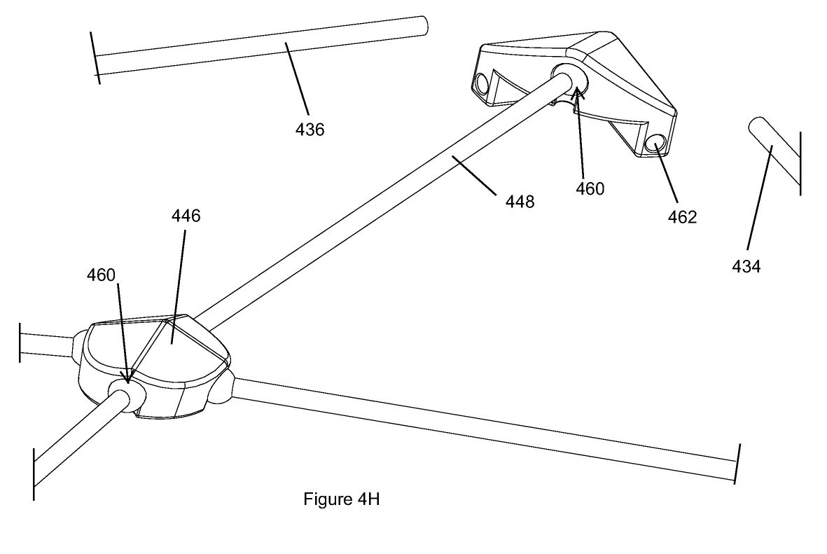

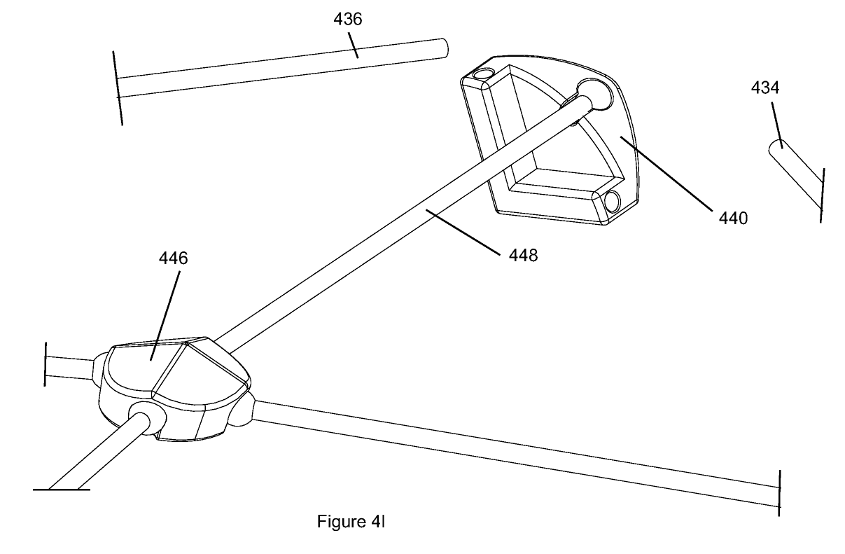

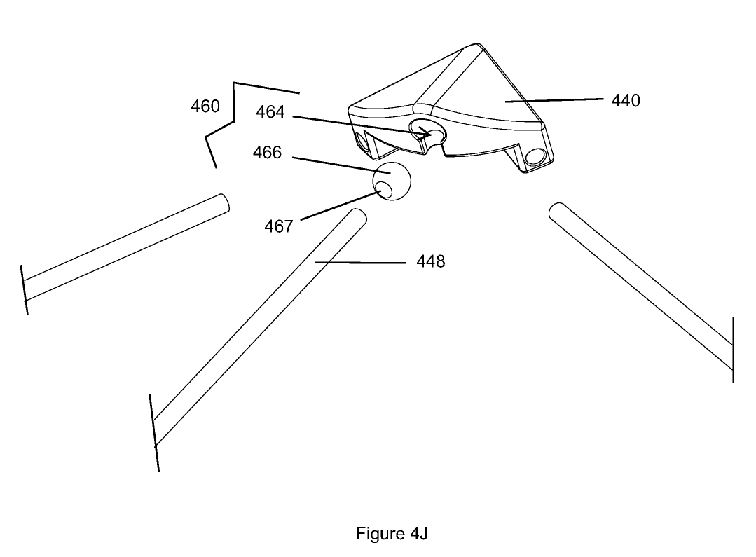

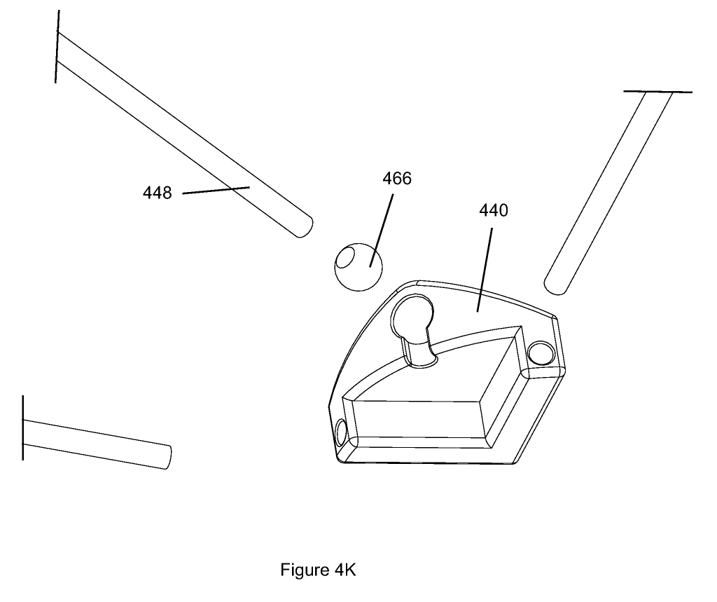

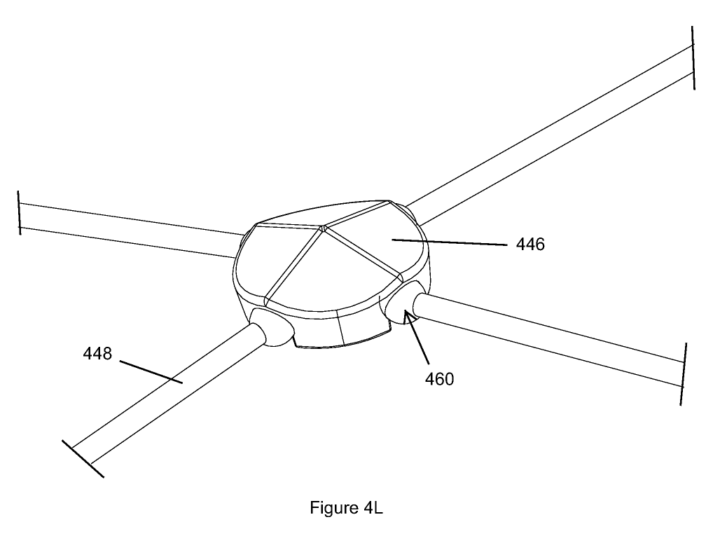

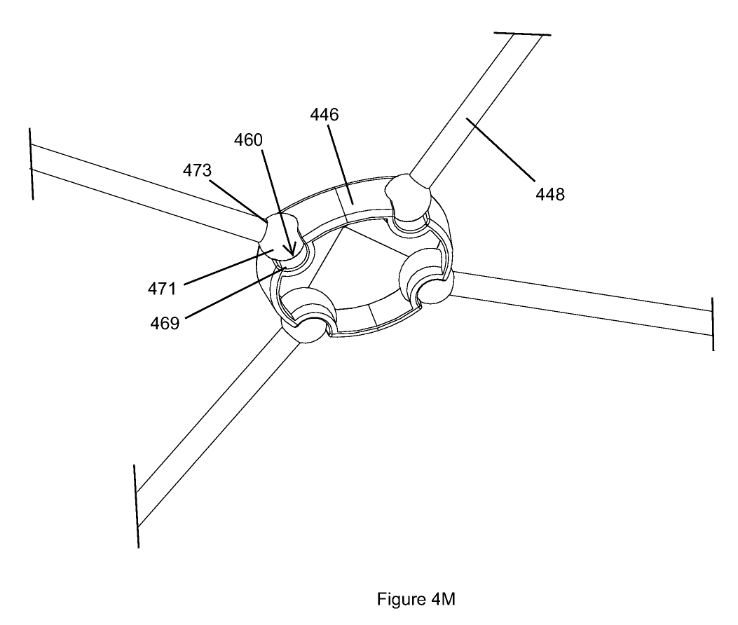

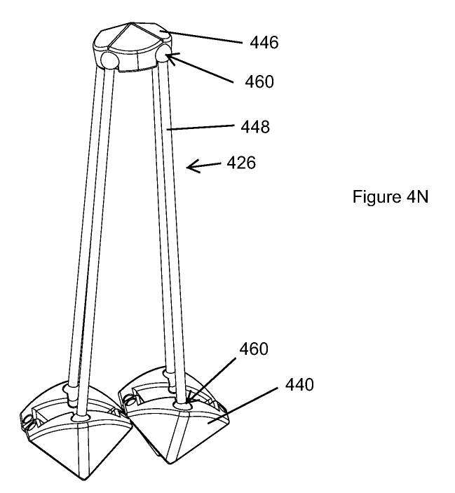

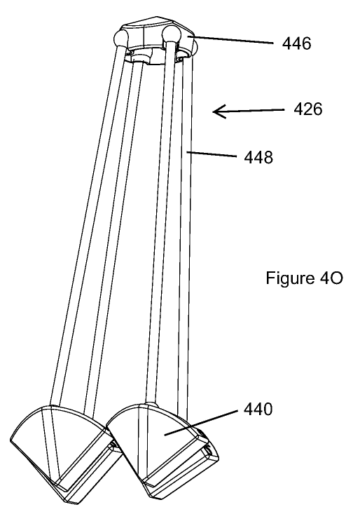

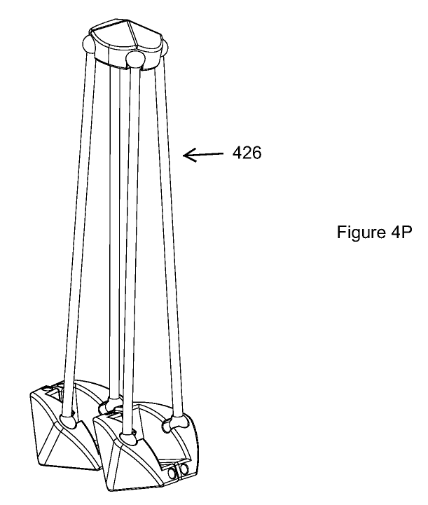

The size, shape, and design of the pet crate 12 can be varied to suit the requirements of the pet. FIG. 2 is a perspective view of one non-exclusive embodiment of the pet crate 12. In this embodiment, the pet crate 12 is generally rectangular shaped and includes a flat, top wall 16; a flat, bottom wall 18, and four flat, side walls 20 that are fastened together to form the pet crate 12. In this design, the four side walls extend between the top wall 16 and the bottom wall 18. Further, one of the side walls 20 includes a pet door 22 that can be selectively opened and closed. Moreover, in this embodiment, the top wall 16 has a top perimeter 16A that is generally rectangular shaped and includes a top width 16B, a top length 16C, and four corners 16D (illustrated in FIG. 4C). It should be noted that the pet crate 12 is FIG. 2 is different in design from the pet crate 12 in FIG. 1. Alternatively, for example, the pet crate 12 could have a cylindrical shape and the top perimeter can have a circular shape.

The type of material used in the pet crate 12 can be varied. As a non-exclusive example, each wall 16, 18, 20 can be made as a wire frame. Alternatively, for example, one or more of the walls 16, 18, 20 can be made of plastic.

Alternatively, the pet crate 12 can have a size or shape different than that illustrated in FIG. 2. For example, in an alternative embodiment, the top wall and the bottom wall can be disk shaped, and the pet crate 12 can include a single, tubular shaped wall.

The design of the crate cover assembly 14 can be varied to suit the design of the pet crate 12. FIG. 2 also illustrates a first embodiment of a frame assembly in which a portion of the crate cover assembly 14 is sized and shaped to fit the rectangular shaped pet crate 12.

In this first embodiment, the crate cover assembly 14 includes a frame assembly 426. The frame assembly 426 is designed to selectively and removably fit the pet crate 12 and support a cover assembly 428 (illustrated in FIG. 4A). In one non-exclusive embodiment, the frame assembly 426 includes (i) a frame base 424 and (ii) a frame support structure 430 that cooperate to support the cover assembly 428 illustrated in FIG. 4A. In one non-exclusive embodiment illustrated in FIG. 2, the frame base 424 also serve as support for detachable side panel curtains 54 secured in a non-extended position by curtain ties 56. The side panel curtains 54 are detachable from the frame base 424. The side panel curtains 54 are made of a flexible material, such as cloth, plastic or other suitable material, and are the desired color and style. The curtain ties 56 are made of a flexible material, such as cloth, plastic, or other suitable material, and are the desired color and style. The curtain ties 56 are detachable from the side panel curtains 54.

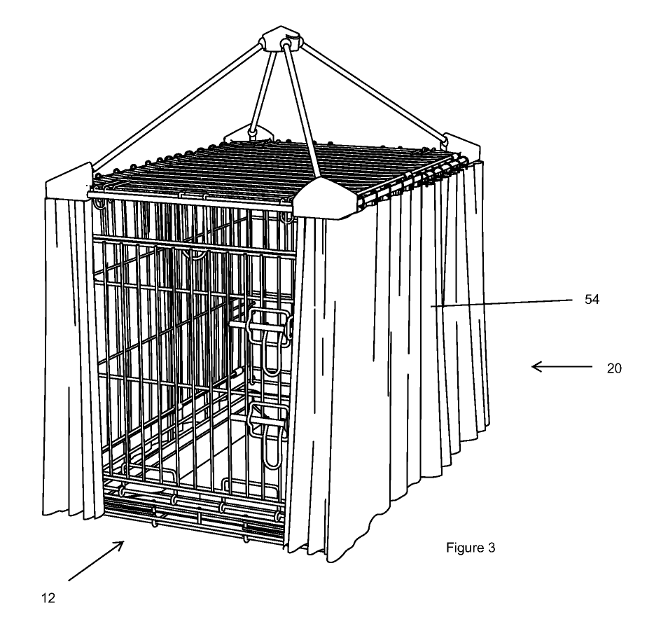

FIG. 3 is an alternate perspective view of FIG. 2 in which the curtain ties 56 illustrated in FIG. 3A have been detached from the side panel curtains 54 and in which the side panel curtains 54 have been extended to cover the side walls 20 of the pet crate 12. With this design, the curtains are both decorative, but can also be moved to selectively encircle and enclose the pet crate 12.

FIG. 4A is a perspective view in which the cover assembly 428 is generally pyramidal in shape and fits over the generally pyramidal-shaped frame support structure 430 (illustrated in FIG. 4B). The design of these components can be varied pursuant to the teachings provided herein.

FIG. 4B is a perspective view of the generally pyramidal-shape frame assembly 426 without the cover assembly 428 (illustrated in FIG. 4A) which is generally pyramidal in shape and fits over the frame assembly 426. The frame support structure 430 is generally pyramidal-shape and the frame base 424 is generally rectangular-shaped to fit on top of the generally rectangular-shaped pet crate 12. It should be noted that the pet crate 12 is illustrated as a square box for simplicity.

FIG. 4C is a perspective view in which the frame base 424 forms a generally rectangular shape to fit on top of a generally rectangular shaped pet crate 12. In this embodiment, the frame base 424 includes a front beam 432, a rear beam 434, two side beams 436, and a plurality of corner connector joints 440. It should be noted that any of these beams could be referred to as a first, second, third, or fourth beam. For example, each of the beams can be tubular shaped.

The front beam 432 is connected to the side beams 436 using the plurality of corner connector joints 440. The rear beam 434 is connected to the side beams 436 using the plurality of corner connector joints 440. In this embodiment, there are four corner connector joints 440, with a separated corner connector joint 440 being positioned at each of the four corners 444 of the frame base 424 and each corner 16D of the crate 12. In this embodiment, the frame support structure 430 is connected at a location above the frame base 424 by a top connector joint 446. Four frame support beams 448, each of which is connected to one corner connector joint 440 and also to the top connector joint 446, form a generally pyramidal shape. The front beam 432, the rear beam 434, and the side beams 436 of the frame base 424 all function as curtain rods for detachable side panel curtains 54 (illustrated in FIG. 3).

FIG. 4D is an alternate perspective view of FIG. 4C.

FIG. 4E is a perspective view in which the top connector joint 446 contains a plurality of ball and socket joints 460 and in which the corner connector joints 440 contain a plurality of ball and socket joints 460. In this embodiment, the top connector joint 446 include four ball and socket joints 460 (one to attach each support beam 448), and each corner connector joint 440 includes one ball and socket joint 460 to attach one of the support beams 448. Stated in another fashion, the frame support beams 448 are connected to the top connector joint 446 using ball and socket joints 460. The frame support beams 448 are also connected to the corner connector joints 440 using ball and socket joints 460. In this embodiment, (i) the top connector joint 446 defines four sockets, with each socket receiving a cylindrical ball that includes an aperture for receiving one of the support beams 448, and (ii) each corner connector joint 440 defines one socket which receives a cylindrical ball that includes an aperture for receiving one of the support beams 448.

In this embodiment, the front beam 432 is connected to two, spaced apart corner connectors 440 through apertures 462 of two corner connector joints 440. The rear beam 434 is connected to two, spaced corner connectors 440 through apertures of two corner connector joints 440. The side beams 436 are connected to two, spaced apart corner connectors 440 through apertures 462 of two corner connector joints 440.

It should be noted that each corner connector 440 can define a right angle shaped groove that engages one of the corner 16D (illustrated in FIG. 4C) of the pet crate 12 to secure the frame base 424 to the pet crate 12.

FIG. 4F is a perspective view in which the frame base 424 (illustrated in FIG. 4B) is adjustable. The frame base 424 is selectively adjusted to conform to the dimensions of the top perimeter 16A (illustrated in FIG. 2) of the pet crate 12 (illustrated in FIG. 2), the top width 16B (illustrated in FIG. 2) of the pet crate 12 (illustrated in FIG. 2), and the top length 16C (illustrated in FIG. 2) of the pet crate 12 (illustrated in FIG. 2). The frame base 424 is selectively adjusted by selectively adjusting the dimensions of the front beam 432, the rear beam 434, and/or the side beams 436 of the frame base 424. For example, each of the tubular shaped beams 432, 434, 436 can be cut to adjust the dimensions. Thus, the frame support structure 430 (illustrated in FIG. 4B) is adjustable. With this design, the frame support structure 430 is selectively adjusted to conform to the dimensions of the pet crate 12 (illustrated in FIG. 4B). The frame support structure 430 is selectively adjusted by selectively adjusting the dimensions of the frame support beams 448 and rotation of the ball and socket joints. It should be noted that the joints could be fixed with an adhesive.

FIG. 4G is an alternate perspective view of FIG. 4F.

FIG. 4H is a partly exploded, perspective view in which a frame support beam 448 is connected to a corner connector joint 440 using a ball and socket joint 460 and in which the frame support beam 448 is connected to a top connector joint 446 using a ball and socket joint 460 (with the respective beam 448 being positioned in an aperture in the ball) and in which a side beam 436 and a rear beam 434 are connected to the corner connector joint 440 by positioning these beams 434, 436 in a separate aperture 462 in the corner connector joint 440. In this embodiment, there are two apertures 462 in the corner connector joint 440.

FIG. 4I is an alternate perspective view with one of the corner connector joints 440 rotated relative to the beam 448, 436, 434.

FIG. 4J is an exploded perspective view in which a corner connector joint 440 contains a socket 464 which receives a ball 466 to connect a frame support beam 448 to the corner connector joint 440. In this embodiment, the ball 466 includes a ball aperture 467 that is sized and shaped to receive one of the support beams 448. It should be noted that the support beam 448 can be positioned within and fixedly secured to the ball 466 with an adhesive.

FIG. 4K is an alternate perspective view of FIG. 4J.

FIG. 4L is a perspective view of a top connector joint 446 containing the plurality of equally spaced apart, ball and socket joints 460 that connect a plurality of frame support beams 448 to the top connector joint 446. In this embodiment, the top connector joint 446 contains four ball and socket joints 460.

FIG. 4M is an alternate perspective view of FIG. 4L. In this embodiment, (i) the top connector joint 446 defines four sockets 469 (semi-cylindrical shaped openings), with each socket 469 receiving a cylindrical ball 471 that includes an aperture 473 for receiving one of the support beams 448.

FIG. 4N is a perspective view of a portion of the frame assembly 426 in a folded configuration, without the beams 432, 434, 436. Again, in this embodiment, the top connector joint 446 contains a plurality of ball and socket joints 460 and in which corner connector joints 440 contain a plurality of ball and socket joints 460 and in which frame support beams 448 are connected to both the top connector joint 446 and to a corner connector joint 440 using ball and socket joints 460. In this embodiment, the front beam 432 (illustrated in FIG. 4F), rear beam 434 (illustrated in FIG. 4F), and side beams 436 (illustrated in FIG. 4F) have been detached from the frame assembly 426 (illustrated in FIG. 4B) and the frame assembly 426 has been compressed from a generally pyramidal shaped to a generally lineal shape for ease of shipping or storage.

FIG. 4O is an alternate perspective view of the portion of the frame assembly 426 of FIG. 4N.

FIG. 4P is an alternate perspective view of the portion of the frame assembly 426 of FIG. 4O.

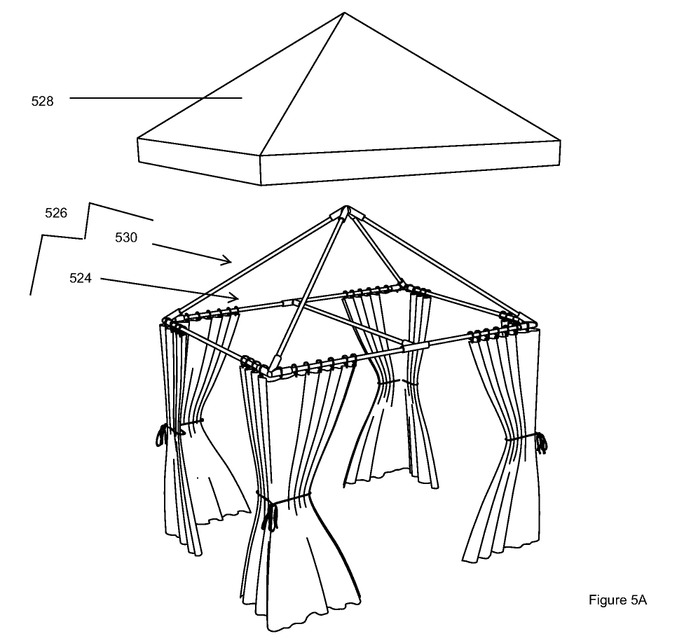

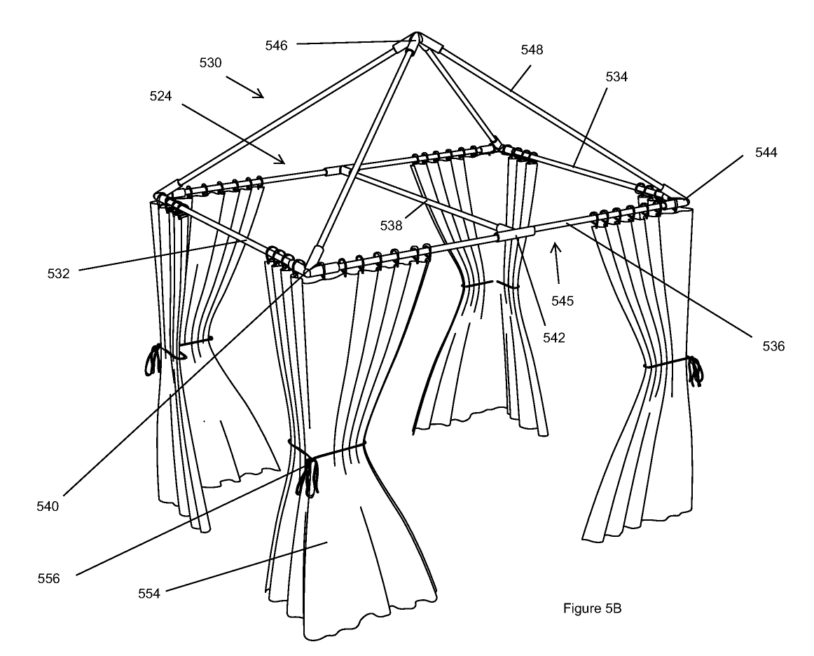

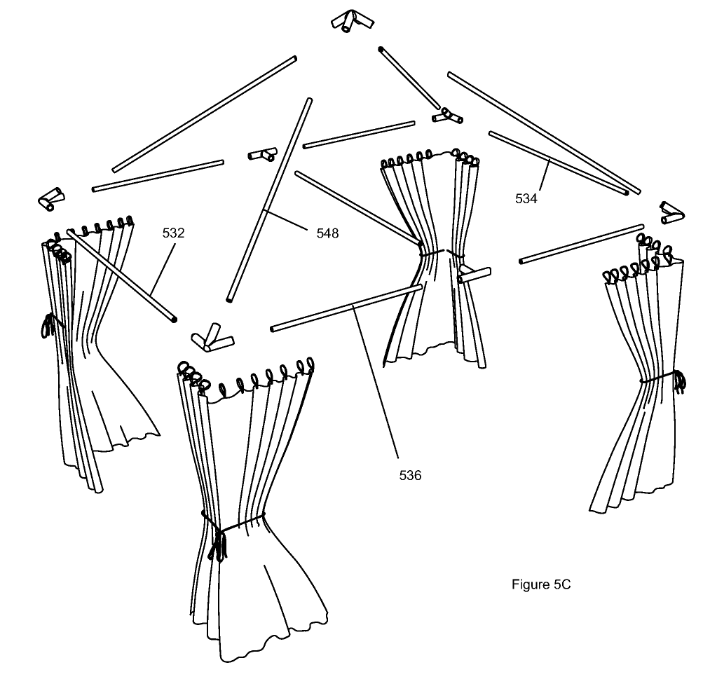

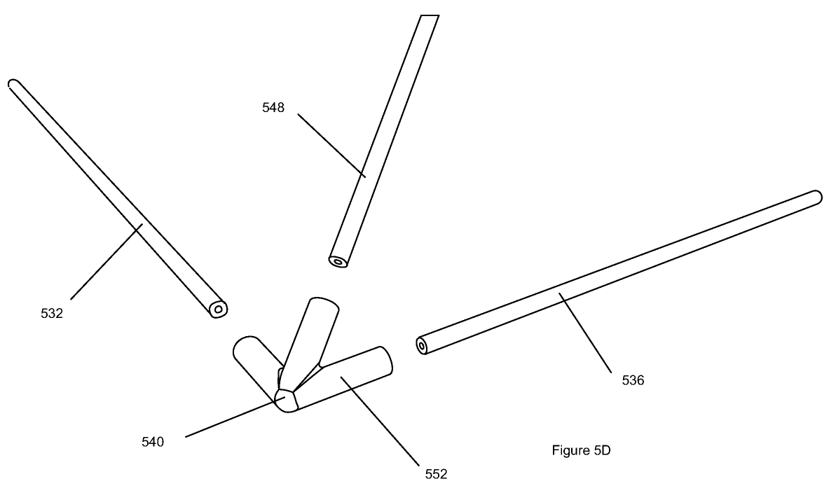

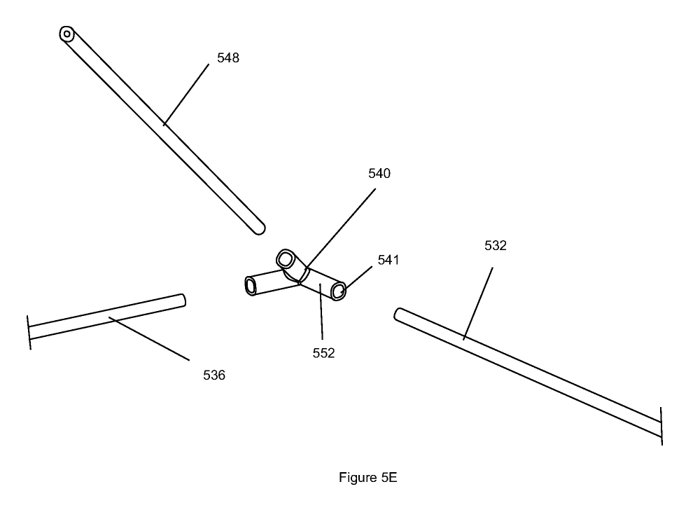

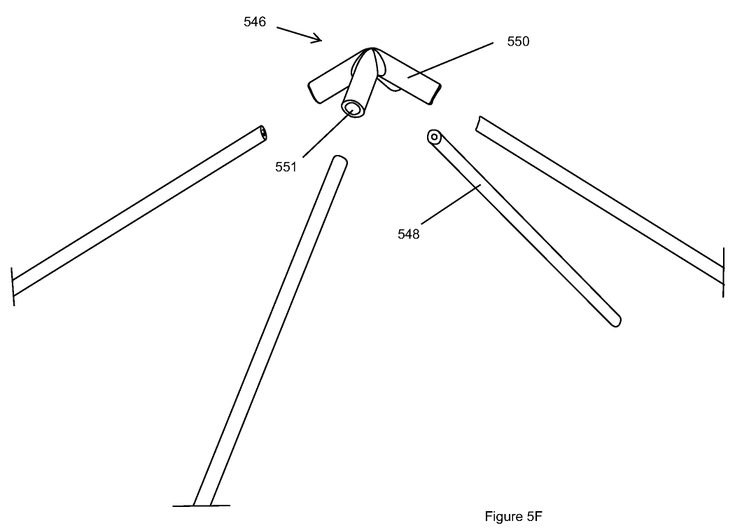

FIG. 5A is a perspective view of a second embodiment in which the cover assembly 528 is generally pyramidal in shape and fits over the generally pyramidal-shape frame assembly 526. The frame support structure 530 is generally pyramidal-shape and the frame base 524 is generally rectangular-shaped. Alternatively, the frame assembly 526 can have another configuration, such as a tent pole design.

FIG. 5B is a perspective view in which the frame base 524 forms a generally rectangular shape. The frame base 524 includes a front beam 532, a rear beam 534, two side beams 536, and an intermediate connector beam 538. The front beam 532 is connected to the side beams 536 using a plurality of corner connector joints 540. The rear beam 534 is connected to the side beams 536 using a plurality of corner connector joints 540. The intermediate connector beam 538 is connected to the side beams 536 using a plurality of side connector joints 542. In this embodiment, there are four corner connector joints 540 at the four corners 544 of the frame base 524 and two side connector joints 542 on the two sides 545 of the frame base 524. The frame support structure 530 is connected at a point above the frame base 524 by a top connector joint 546. Four frame support beams 548, each of which is connected to a corner connector joint 540 and also to the top connector joint 546, form a generally pyramidal shape. The front beam 532, the rear beam 534, and the side beams 536 of the frame base 524 all function as curtain rods for side panel curtains 554. In this embodiment, the side panel curtains 554 are tied at the four corners 544 of the frame base 524 using curtain ties 556. Alternatively, the side panel curtains 554 may be untied and extended so that they cover the side walls 20 of the pet crate 12 (illustrated in FIG. 3).

FIG. 5C is a perspective view in which the frame base 524 (illustrated in FIG. 5A) is adjustable. The frame base 524 is selectively adjusted to conform to the dimensions of the top perimeter 16A (illustrated in FIG. 2) of the pet crate 12 (illustrated in FIG. 2), the top width 16B (illustrated in FIG. 2) of the pet crate 12 (illustrated in FIG. 2), and the top length 16C (illustrated in FIG. 2) of the pet crate 12 (illustrated in FIG. 2). The frame base 524 is selectively adjusted by selectively adjusting the dimensions of the front beam 532, the rear beam 534, and/or the side beams 536 of the frame base 524. The frame support structure 530 (illustrated in FIG. 5A) is adjustable. The frame support structure 530 is selectively adjusted to conform to the dimensions of the crate cover assembly 428 (illustrated in FIG. 4A). The frame support structure 530 is selectively adjusted by selectively adjusting the dimensions of the frame support beams 548.

FIG. 5D is a perspective view in which a front beam 532, a side beam 536, and a frame support beam 548 are all detached from a corner connector joint 540 with a plurality of corner connector prongs 552. In this embodiment, the corner connector joint 540 has three corner connector prongs 552.

FIG. 5E is an alternate perspective view of FIG. 5D. In this embodiment, each corner connector joint 540 defines three cylindrical shaped apertures 541, with each aperture 541 being sized and shaped to receive a portion of one of the beams 532, 536, 548. In one embodiment, each beam 532, 536, 538 is tubular shaped and each aperture 541 is tubular shaped.

FIG. 5F is a perspective view in which a plurality of frame support beams 548 are detached from a top connector joint 546 containing a plurality of top connector prongs 550. In this embodiment, there are four frame support beams 548 and four top connector prongs 550. Further, in this embodiment, each top prong 550 defines an aperture 551 that is sized and shaped to receive a portion of one of the beams 548. In one embodiment, each beam 548 is tubular shaped and each aperture 551 is tubular shaped.

It should be noted that the combination of the pet crate and the crate cover assembly can have other shapes and dimensions than illustrated herein. For example, the top of the pet crate can be round and the crate cover assembly can be designed to fit the round pet crate.

While a number of exemplary aspects and embodiments of a crate cover assembly 14 have been shown and disclosed herein above, those of skill in the art will recognize certain modifications, permutations, additions and sub-combinations thereof. It is therefore intended that the crate cover assembly 14 shall be interpreted to include all such modifications, permutations, additions and sub-combinations as are within their true spirit and scope, and no limitations are intended to the details of construction or design herein shown.

What is claimed is:

1. A crate cover assembly for covering a pet crate, the pet crate including a crate top having a crate top perimeter, a crate bottom perimeter, and at least one crate side wall, the crate cover assembly comprising:
a frame assembly positioned on the crate top, the frame assembly including (i) a frame base having a base perimeter that is sized and shaped to match the size and shape of the top perimeter of the pet crate, and (ii) a frame support structure that extends upward from the frame base; and a cover assembly that fits over and covers the frame assembly.

2. The pet crate cover assembly of claim 1 wherein the frame base is generally rectangular shaped, the frame support structure is pyramidal shaped and includes a plurality of support rods extending away from the frame base, and the cover assembly includes a top cover that is pyramidal shaped.

3. The pet crate cover assembly of claim 1 wherein the pet crate cover assembly includes at least one side curtain that selectively attaches to the frame support structure to cover at least a portion of the crate side wall.

4. A combination including the pet crate cover assembly of claim 3 and a pet crate that is generally rectangular shaped with four crate side walls, a crate top perimeter and a crate bottom perimeter, and at least one pet door.

5. The pet crate cover assembly of claim 1 wherein the frame base includes a base perimeter, and wherein the frame base is adjustable to change the size and shape of the base perimeter.

6. The pet crate cover assembly of claim 5 wherein the frame base includes a plurality of adjustable joints.
